(19) United States
(12) Patent Application Publication
(10) Pub. No.: US 2024/0146556 A1
(43) Pub. Date: May 2, 2024

(54) MULTICAST TRAFFIC FORWARDING IN OVERLAY NETWORKS

(71) Applicant: HEWLETT PACKARD ENTERPRISE DEVELOPMENT LP, Spring, TX (US)

(72) Inventors: Vinayak Joshi, Bangalore (IN); Tathagata Nandy, Bangalore (IN)

(21) Appl. No.: 18/051,121

(22) Filed: Oct. 31, 2022

(51) Int. Cl. H04L 12/18; H04L 45/64; H04L 45/7453

(52) U.S. Cl. CPC H04L 12/18; H04L 45/64; H04L 45/7453

(57) ABSTRACT

In an example, a network switch may receive a join request, for a multicast group indicated by an overlay multicast address, from a remote network switch. The network switch may be coupled to a source host device and the remote network switch may be coupled to a receiver host device of the multicast group. The network switch and the remote network switch may be configured as virtual endpoints in an overlay network deployed over an underlay network. The network switch may map the overlay multicast address to an underlay multicast address and the remote network switch may join the multicast group represented by the underlay multicast address. The network switch may receive multicast (traffic for the multicast group from the source host device and encapsulate the multicast traffic with a destination address identical to the underlay multicast address. The network switch may then forward the multicast traffic to the multicast group via the underlay network based on the destination address. The receiver host device may receive the multicast traffic via the remote network switch.

### BACKGROUND

Generally, a computer network may include one or more local area networks (LANs) of interconnected devices. Network traffic may be sent to different destinations in the computer network by using one of the ethernet modes, viz., broadcast, unicast, and multicast. Broadcast refers to transmission of data packets from a single source to all hosts on a single local subnet. Unicast refers to transmission of data packets from a single source to a single specified destination. Multicast refers to transmission of data packets from one or more sources to a group of destination devices. Network traffic that is forwarded to multiple destinations using multicast mode of communication may be referred to as multicast traffic.

### BRIEF DESCRIPTION OF THE DRAWINGS

For a more complete understanding of the present disclosure, examples in accordance with the various features described herein may be more readily understood with reference to the following detailed description taken in conjunction with the accompanying drawings, where like reference numerals designate like structural elements, and in which:

FIG. 1A schematically illustrates a network environment implementing a network switch for multicast traffic handling, according to an example;

FIG. 1B illustrates a block diagram of an example network switch for multicast traffic handling, according to an example;

FIG. 2 illustrates bitmap notations of multicast addresses which may be generated, according to an example;

FIG. 3 illustrates a flowchart illustrating a method for multicast traffic handling, according to an example;

FIG. 4 illustrates another flowchart illustrating a method for multicast traffic handling, according to an example; and

FIG. 5 illustrates a computing device for implementing the method for multicast traffic handling, according to an example.

Certain examples have features that are in addition to or in lieu of the features illustrated in the above-referenced figures. Certain labels may be omitted from certain figures for the sake of clarity.

### DETAILED DESCRIPTION

The computer network may have an underlay network which includes the physical network infrastructure of network devices for transporting packets from source to destination and an overlay network which is a virtual network deployed on top of the underlay network. A layer 2 (L2) network may be stretched across multiple layer 3 (L3) networks by implementing overlays. Layer 2, also known as the data link layer, is the second level in the seven-layer Open System Interconnection (OSI) reference model for network protocol design. Layer 2 is the protocol layer used to transfer data between adjacent network nodes in a wide area network or between nodes on the same local area network. Layer 3, also known as the Network Layer, is the third level in the seven-layer OSI reference model for network protocol design. Layer 3 provides the functional and procedural means of transferring data packets from a source host on one network to a destination host on a different network (in contrast to the data link layer which connects hosts within the same network). The network layer performs network routing functions, and may also perform fragmentation and reassembly, and report delivery errors. The overlay network may be implemented using different network virtualization technologies which allow abstracting hardware network resources to software. The network virtualization technologies provide a framework for overlaying virtualized layer 2 networks over layer 3 networks, defining both an encapsulation mechanism and a control plane. Examples of network virtualization technologies include Virtual Extensible Local Area Network (VXLAN), Generic Network Virtualization Encapsulation (GENEVE), and Network Virtualization using Generic Routing Encapsulation (NVGRE). Overlay networks provide L2 connectivity between endpoints that may be deployed across different L3 network domains. Since those endpoints are logically part of the same L2 network domain, they should be capable of sending and receiving L2 multi-destination frames, such as, multicast traffic. Thus, scalability of the overlay network depends on how well it can handle multicast traffic.

The present subject matter involves techniques of handling multicast traffic in overlays by mapping an overlay address of a multicast group to an underlay address based on a hashing of the overlay address. By selecting a set of hash functions using a bloom filter technique for hashing the overlay multicast address to map it to an underlay multicast address, the overlay multicast address gets mapped to an underlay multicast address with reduced chances of hash collisions. The underlay multicast address obtained by the hashing is consistently used as an address of the multicast group for traffic delivery and consequently, the underlay switches and overlay endpoints join the multicast group represented by the underlay address. Thus, the underlay switches are not required to be configured with overlay network information but can still deliver multicast traffic for the overlay. Further, the present subject matter also allows in traffic delivery to the multicast group without any additional protocol extensions or additional headers to the traffic.

Generally, multicast traffic may be handled in overlay networks in two ways, viz., (i) Multicast routing and (ii) Ingress replication. In multicast routing, a unique multicast group address is mapped to each overlay network identifier in the overlay network. The multicast traffic for each overlay network identifier is forwarded to the group address configured for the overlay network identifier and all virtual endpoints with that overlay network identifier listen to that group. So, they get the multicast traffic. An overlay network identifier refers to a logical identifier for a specific overlay network. A multicast group may be a group of hosts defined by an IP address which may receive data packets that are sent to that group. When a virtual endpoint in the overlay network comes alive it may join the multicast groups for the overlay network identifiers it uses. When the virtual endpoint has to send multicast traffic, the virtual endpoint will send the traffic only to the relevant multicast group and other virtual endpoints which are participants in the multicast group may receive the multicast traffic. With multicast routing a single copy of the multicast traffic is forwarded to multiple destinations.

In ingress replication, multicast capabilities are not enabled in the underlay network. Virtual endpoints in the overlay network may advertise among themselves the overlay network identifiers configured in each of the virtual endpoints. A virtual endpoint receiving multicast traffic intended for a set of virtual network identifiers may create multiple copies of the multicast traffic and may send the multicast traffic to the virtual endpoints configured with one of the virtual network identifiers of the set.

However, each of the two mechanisms discussed above have their own challenges. Multicast routing of multicast traffic requires manual configuration to be performed in each of the virtual endpoints of the overlay or switches in the underlay which may be cumbersome. This is because, whenever a host device joins or leaves a multicast group, a change may be required in the unique multicast group address mapped to each overlay network identifier for optimal delivery of multicast traffic. Since, host devices may join or leave multicast groups quite frequently, this may require frequent manual intervention for re-configuration of the virtual endpoints in the overlay or switches in the underlay. This frequent manual intervention may be complex and cumbersome and may lead to errors in configuration of the virtual endpoints and switches.

Ingress replication requires higher bandwidth since multiple copies of the same traffic is transmitted in the overlay network. These multiple copies may choke the network, particularly a network which runs high data rate multicast-based applications, such as conference calls using Voice over Internet Protocol (VoIP), IPTV, corporate training videos, etc. Further, for ingress replication, exchange of routing and reachability information among the virtual endpoints is a pre-requisite which may require additional protocol support.

Techniques of the present disclosure involve mapping an overlay address of a multicast group to an underlay address of the multicast group using a hashing mechanism and forwarding the multicast traffic via the underlay network to the multicast group using the underlay address. Since, a mapping between a unique multicast group address to each overlay network identifier is not required in the techniques of the present disclosure, manual effort in configuring each virtual endpoint whenever a host device joins or leaves a multicast group may be avoided. Thus, manual effort and complexities in configuring virtual endpoints or switches otherwise involved in multicast routing of multicast traffic may be avoided. Also, since a single copy of the multicast traffic is forwarded to the underlay address of the multicast group obtained on hashing, multiple copies of the multicast traffic is not generated as otherwise arising during ingress replication. Thus, the techniques of the present disclosure may provide for handling of multicast traffic in an overlay network without cumbersome manual configuration of virtual endpoints and without choking the network with multiple copies of the traffic.

In an example, a source host device may be coupled to a network switch. The source host device may generate multicast traffic for a multicast group indicated by an overlay multicast address. There may be a remote network switch coupled to a receiver host device interested to receive the multicast traffic of the multicast group. The network switch and the remote network switch may be configured as virtual endpoints in an overlay network deployed over an underlay network. The network switch may receive a join request for the multicast group indicated by the overlay multicast address from the remote network switch and map the overlay multicast address to an underlay multicast address based on a hash of the overlay multicast address. In response to receiving multicast traffic for the multicast group from the source host device, the network switch may encapsulate the multicast traffic with a destination address identical to the underlay multicast address. The network switch may forward the multicast traffic to the multicast group via the underlay network based on the destination address, such that the receiver host device receives the multicast traffic via the remote network switch. Thus, multicast traffic may be delivered from the source host device to the receiver host device without complex manual configuration at the switches otherwise occurring in multicast routing in overlays and by further avoiding duplication of traffic as may otherwise occur with ingress replication.

Further, the present disclosure may use a set of hash functions configured using a bloom filter technique to map the overlay multicast address to the underlay multicast address. Each of the hash functions maps the overlay multicast address to a bit position in an IP address field of the underlay multicast address. This reduces chances of hash collisions which could have resulted from two different overlay multicast addresses getting mapped to a single underlay multicast address. Thus, hash collisions during mapping of the overlay multicast address to the underlay multicast address may also be avoided/reduced resulting in smooth traffic forwarding.

The described systems and methods may be implemented in various switches in a communication network. Although, the description above references to access switches, the methods and described techniques may be implemented in other type of switches implementing different communication techniques, albeit with a few variations. Various implementations of the present subject matter have been described below by referring to several examples.

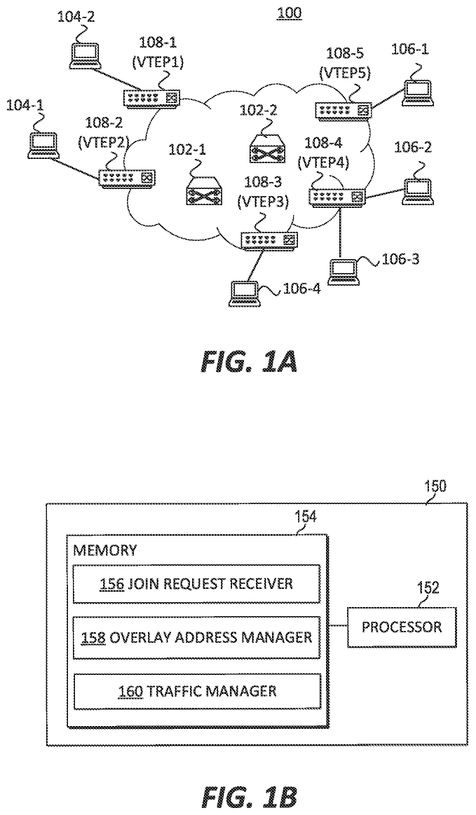

The above systems and methods are further described with reference to FIG. 1A to FIG. 5. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and embodiments of the present subject matter, as well as specific examples thereof, are intended to encompass equivalents thereof.

FIG. 1A schematically illustrates a network environment 100. In an example, the network environment 100 may be a computer network made up of an interconnection of LANs within a limited geographical area. In one example, the network environment 100 may include a campus network. The network environment 100 may include a plurality of underlay switches 102-1 and 102-2, collectively referred to as underlay switches 102. Each of the underlay switches 102 may be implemented as, but not limited to, a switching unit, a switch-router, or any device capable of switching data packets provide connectivity between hosts in a computer network, such as the network environment 100. Further, although some switches 102 have been depicted in the network environment 100, it would be understood that the network environment may implement several other switches, routers, and hosts.

As shown in FIG. 1A, the network environment 100 includes host devices 104-1 and 104-2. The host devices 104-1 and 104-2 may be collectively referred to as source host devices 104. In the description hereinafter, each of the source host devices 104 may be individually referred to as source S. Source S may be a computing device that communicates with other host devices on the network environment 100. Host devices on the network environment 100 may include clients and servers that send or receive data, services or applications. The host devices may be connected with each other over physical links via switches, such as switches 102. The network environment 100 further includes receiver host devices 106-1 to 106-4, collectively referred to as receiver host devices 106. In the description hereinafter, each of the receiver host devices 106 may be individually referred to as receiver R. A source S may be understood as a network node from which multicast traffic in the network environment 100 originates while a receiver R may be understood as the final destination of the multicast traffic originating from the source S.

In an example, one or more of the receiver host devices 106 may be part of a multicast group. A multicast group may refer to a group of host devices which may be represented by at least one of a single multicast group address, such as a multicast IP address, and a port number. In an example, a multicast IPv4 address may lie in the range between 224.0.0.0 and 239.255.255.255. Once a host device is part of a multicast group, it may receive the traffic sent to the multicast IP address and/or port number. In an example, the receiver host devices 106-1 and 106-2 may form part of a multicast group G1 and the receiver host devices 106-3 and 106-4 may form part of a multicast group G2. Thus, traffic sent to group G1 may be received by the receiver host devices 106-1 and 106-2 and traffic sent to the group G2 may be received by the receiver host devices 106-1 and 106-2.

The network environment 100 also includes network virtualization overlays (NVO). NVOs, also referred to as overlay networks, include implementing software-based virtualization to create additional layers of network abstraction (also called software-based network overlays) that can be run on top of the physical network, often providing new applications or security benefits. Virtual Extensible Local Area Networks (VXLANs), Generic Routing Encapsulation (GRE), and Network Virtualization using Generic Routing Encapsulation (NVGRE) are examples of NVOs.

Overlay networks allow layer 2 connections to be stretched over a layer 3 network by encapsulating ethernet frames which include IP addresses. Thus, a layer 2 overlay network is formed on top of a layer 3 underlay network. Using overlays, traffic may pass through the layer 3 routing architecture while using the layer 2 data packet addresses for routing. An overlay network may include virtual tunnel endpoints (VTEPs) which may be either virtual or physical switch ports. The VTEPs may encapsulate data packets entering the overlay network from a source host device and de-encapsulate the data packets when they leave the overlay network.

Network environment 100 of FIG. 1A includes switches 108-1 to 108-5. Each of the switches 108-1 to 108-5 may be configured as a VTEP and may be collectively referred to as VTEPs 108. Thus, switch 108-1 may be referred to as VTEP1, switch 108-2 as VTEP2, switch 108-3 as VTEP3, and so on. The VTEPs 108 may connect to each other via virtual tunnels in the overlay network. In an example, VTEP1 and VTEP2 may be referred to as ingress VTEPs or source VTEPs and VTEP3, VTEP4, and VTEP5 may be referred to as egress VTEPs or receiver VTEPs. An ingress VTEP refers to a virtual endpoint in a network which is connected to a traffic source, such as source S, and which may receive traffic from the traffic source and process (for example encapsulate) the traffic entering the network. An egress VTEP refers to a virtual endpoint in a network which is connected to a traffic receiver, such as receiver R, and which may receive traffic from the network and process (for example decapsulate) the traffic exiting the network.

In an example, a data packet addressed to a multicast group may originate from a source host device 104-2. The multicast group may have an overlay multicast address G and may include receiver host devices 106-1 and 106-2. The source host device 104-2 may send the data packet to an ingress VTEP, VTEP1, which may create a mapping of the overlay multicast address G to an underlay multicast address D and share the mapping with all VTEPs in the network environment 100. VTEP1 may map the overlay multicast address G to the underlay multicast address D using a bloom filter technique thereby avoiding hash collisions. Egress VTEPs, VTEP4 and VTEP5, participating in the multicast group with overlay multicast address G may join the multicast group with underlay multicast address D. VTEP1 may encapsulate the data packet received from source host device 104-2 with the underlay multicast address D as the destination address and may forward the data packet through the underlay switches 102 to the destination address D. The underlay switches 102 may forward the data packet to destination address D which represents the multicast group of VTEP4 and VTEP5. Thus, egress VTEPs, VTEP4 and VTEP5, may receive the data packets from the underlay switches 102 and decapsulate them. Based on the mapping between underlay multicast address D and the overlay multicast address G, VTEP4 and VTEP5 may forward the data packet to the receiver host devices 106-1 and 106-2, respectively. Thus, using the mapping between the overlay multicast address and the underlay multicast address, the underlay switched and VTEPs may deliver traffic to multicast groups in the overlay network without any additional protocol extensions or additional headers to the traffic.

The network environment 100 may be a wired network, a wireless network, or a combination thereof. The network environment 100 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

Turning now to FIG. 1B an example network switch 150 is shown. The network switch 150 may be similar to switches 108-1 or 108-2 illustrated in FIG. 1A. In examples discussed herein, the network switch 150 may be considered to operate similar to a switch 108-1 implementing an ingress VTEP, VTEP1, connected to source host device 104-2. Network switch 150 may include a processor 152 and a memory 154 that may be coupled to each other through a communication link (e.g., a bus). Processor 152 may include a single or multiple Central Processing Units (CPU) or another suitable hardware processor(s), such as a network ASIC. Memory 154 may be a machine-readable storage medium that may store machine readable instructions executed by processor 152. Memory 154 may include any suitable combination of volatile and/or non-volatile memory, such as combinations of Random Access Memory (RAM), Read-Only Memory (ROM), flash memory, and/or other suitable memory.

Memory 154 stores instructions to be executed by processor 152 including instructions for join request receiver 156, overlay address manager 158, and traffic manager 160.

The processor 152 may execute join request receiver 156 to receive a join request, for a multicast group, from a remote network switch. The remote network switch may implement an egress VTEP, such as VTEP5 of FIG. 1A, coupled to a receiver R of the multicast group. As may be understood, the network switch 150 and the remote network switch may be configured as an ingress VTEP and an egress VTEP, respectively, in an overlay network deployed over an underlay network. The join request may be a network layer protocol communication sent by the remote network switch indicating that it is interested to receive data packets addressed to the multicast group as it is coupled to active members, i.e., receiver host devices, of the multicast group. In an example, the join request may be a Protocol Independent Multicast (PIM) join request. The multicast group may be indicated by an overlay multicast address. The overlay multicast address refers to a logical identifier for a multicast group in an overlay network and, in an example, may include a multicast IP address in an overlay address space. The multicast IP address refers to a logical identifier for a group of host devices in a computer network that intend to receive data packets which are addressed to the group from a source or network service. In an example, a range of multicast IP addresses for an IPv4 network may be in between 224,0.0.0 and 239.255.255.255. The overlay address space refers to a subset of the multicast IP addresses designated for use by network entities in an overlay network.

In an example, the multicast group may be one of a source specific multicast (SSM) group or an any source multicast (ASM) group. The SSM group refers to a group of hosts devices which intend to receive data packets originating from a specific source host device and addressed to the group. The SSM group may be represented by an overlay multicast address (S, G), where S denotes the IP address of the specific source host device and G denotes the multicast IP address. The ASM group refers to a group of hosts devices which intend to receive any data packets that are addressed to the group. The data packets received by hosts in an ASM group may originate from same or different sources sending multicast traffic. The ASM group may be represented by an overlay multicast address (*, G), where * denotes that multicast data packets from any source that may be received by the group and G denotes the multicast IP address. Thus, the overlay multicast address may be denoted as (*, G) for an ASM group or (S, G) for an SSM group.

In an example, the remote network switch may generate the join request in response to receiving a group membership request from a receiver R coupled to it. The group membership request may be a network layer protocol communication sent by the receiver R to the remote network switch expressing interest to receive data packets addressed to the multicast group. The group membership request may include the overlay multicast address. In an example, the group membership request may be an Internet Group Management Protocol (IGMP) membership request.

The processor 152 may execute the overlay address manager 158 to map the overlay multicast address to an underlay multicast address. The underlay multicast address refers to a logical identifier for a multicast group in an underlay network and, in an example, may include a multicast IP address in an underlay address space. The underlay address space refers to a subset of the multicast IP addresses which may be designated for use by network entities in an underlay network.

In an example, the processor 152 may execute overlay address manager 158 to determine a set of hash values. Each of the set of hash values may be obtained by hashing the overlay multicast address using one of a set of hash functions. The set of hash functions may be stored in each of the VTEPs, such as VTEP1 to VTEP5 in FIG. 1A. In an example, the set of hash functions may be configured using a bloom filter technique, such that each of the set of hash values corresponds to a bit position in an IP address field of the underlay multicast address. The IP address field is a representation of the underlay multicast address in binary notation. Further, the processor 152 may execute the overlay address manager 158 to set the value of a bit corresponding to the bit position as one. Thus, the overlay multicast address may be mapped to the underlay multicast address. The mapping of the overlay multicast address to the underlay multicast address is described in further detail later in the description.

The processor 152 may execute the traffic manager 160 to receive multicast traffic for the multicast group from a source host device. In an example, the source host device may generate data packets addressed to the multicast group and forward the same to the network switch 150 configured as an ingress VTEP. The processor 152 may execute the traffic manager 160 to encapsulate the multicast traffic with a destination address identical to the underlay multicast address obtained by hashing the overlay multicast address for the group. In an example, the encapsulation is a VXLAN encapsulation, where a Media Access Control (MAC)-in-User Datagram Protocol (UDP) encapsulation scheme is used. In the MAC-in-UDP encapsulation scheme, a VXLAN header is added to the original L2 frame and is then placed in a UDP-IP packet. The underlay multicast address is used as a destination IP address in the UDP-IP packet. The underlay switches may now use the underlay multicast address as the destination IP address while forwarding data packets for the multicast group without being aware of the overlay network topology. Thus, the underlay switches are not required to be configured with overlay network information but can still deliver multicast traffic for the overlay. Consequently, manual configuration of the underlay switches with overlay network information may be avoided.

Further, the processor 152 may execute the traffic manager 160 to forward the multicast traffic to the multicast group via the underlay network based on the destination address, such that the receiver R receives the multicast traffic via the remote network switch. Thus, in an example, multicast traffic in the overlay network may be forwarded between a source host device and a receiver host device via the underlay switches using an underlay multicast address mapped to an overlay multicast address without adding protocol extensions or additional headers to the traffic.

In an example, exchange of multicast traffic between a source host device 104-2 (also referred to as source S) and a receiver host device 106-1 (also referred to as receiver R) belonging to a multicast group having multicast IP address G is described hereinafter with reference to FIG. 1A. Before data packets are forwarded, the network environment 100 is configured for exchange of multicast traffic. In an example, the receiver R may send a group membership request to join a multicast group G. The group membership request may indicate the receiver host device R's interest to receive traffic from the source S addressed to the multicast group G. In another example, the group membership request may only indicate an IP address “G” of the multicast group, in which case, the group membership request indicates the receiver host device R's interest to receive traffic from any source host device addressed to the multicast group G. The receiver R may send the group membership request to the switch 108-5, configured as VTEP5.

In response to receiving the group membership request from the receiver R, VTEP5 may send a join request to other VTEPs, such as VTEP1 to VTEP4. In an example, the join request may be a PIM join request. The join request may indicate that VTEP5 is interested to receive data packets addressed to multicast group having overlay multicast address (S, G). The multicast group having overlay multicast address (S, G) is also referred to as multicast group (S, G). The multicast group (S, G) may include a set of host devices which are interested to receive data packets originating from source S and addressed to multicast group G.

In response to receiving the join request from VTEP5, VTEP1 may determine a set of hash values. Each of the set of hash values may be obtained by applying a hash function, from a set of hash functions, on the overlay multicast address (S, G) of the multicast group. In an example, the set of hash functions may be stored in each of the VTEPs, i.e., VTEP1 to VTEP5. The set of hash functions are configured using a bloom filter technique. In an example bloom filter technique, the hash functions in the set are configured such that the set of hash values range between 1 to M, where M corresponds to a maximum number of variable-value bits in an IP address field of the underlay multicast address corresponding to the overlay multicast address (S, G). A variable-value bit refers to a bit in the IP address field whose value may be varied between 0 and 1 to obtain the underlay multicast address.

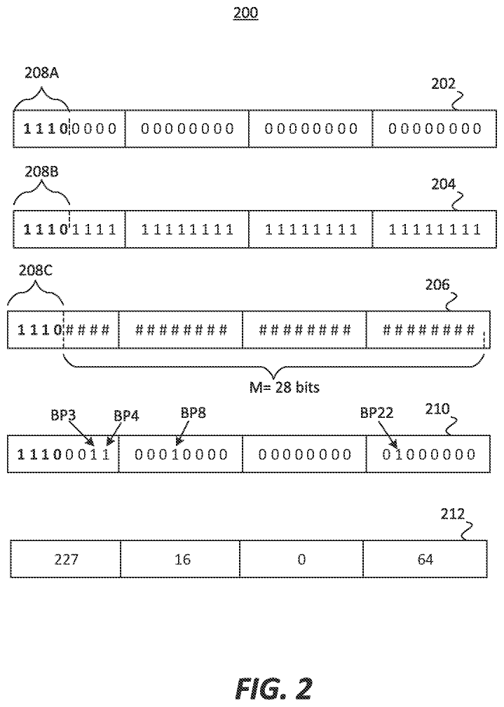

In an example, the value of M may be determined as below. Generally, IPv4 multicast addresses have a lower limit of 224.0.0.0 and an upper limit of 239.255.255.255. Referring to FIG. 2, the lower limit of IPv4 multicast addresses may be expressed in binary notation as lower limit 202. The upper limit of the range of IPv4 multicast addresses may be expressed in binary notation as upper limit 204. As may be noted from FIG. 2, the upper nibble 208A of the lower limit 202 and the upper nibble 208B of the upper limit 204 are identical. A nibble refers to a four-bit aggregation, or half an octet from a set of bits. Since, in an example, the underlay multicast address lies within the range of IPv4 multicast addresses, the upper nibble of the underlay multicast address shall be set to “1110” shown as upper nibble 208C in IP address field 206 of the underlay multicast address. Once the upper nibble is fixed, 28 variable-value bits remain available, as represented by “#”. Each of the #'s indicate a bit in the IP address field 206 whose value may be varied between 0 and 1 to obtain the underlay multicast address. Thus, the value of M, in this example, is 28. According to this example, the hash functions in the set may be configured such that the set of hash values range between 1 to 28.

An example mapping of an overlay multicast address (S, G) to an underlay multicast address is explained herein. Consider that the source IP address S is 1.1.1.1 and the multicast IP address G is 250.1.1.1. Thus, the overlay multicast address may be represented as (S, G), i.e., (1.1.1.1, 250.1.1.1). In this example, VTEP1 on receiving the join request with the overlay multicast address, may execute an overlay address manager, such as the overlay address manager 158, to determine a set of hash values. The overlay address manager may determine the set of hash values as following (considering there are four hash functions implemented in VTEP1):
Hash1(1.1.1.1, 250.1.1.1)=3
Hash2(1.1.1.1, 250.1.1.1)=22
Hash3(1.1.1.1, 250.1.1.1)=8
Hash4(1.1.1.1, 250.1.1.1)=4

Each of the set of hash values correspond to a bit position in the IP address field 206 of the underlay multicast address. Thus, Hash1 represents bit position 3, Hash2 represents bit position 22, Hash3 represents bit position 8, and Hash4 represents bit position 4. The VTEP1 may execute the overlay address manager to set the value of a bit corresponding to each of the bit positions represented by the hash values as “1”. The bits corresponding to the remaining bit positions may be reset to 0. Referring to FIG. 2, the bit position 3 is denoted as BP3, bit position 4 is denoted as BP4, bit position 8 is denoted as BP8, and bit position 22 is denoted as BP22. The values of the bits in BP3, BP4, BP8, and BP22 are set as “1” and the remaining bits are reset to “0”. Thus, we may obtain the underlay multicast address 210 (in binary notation) which is the underlay multicast address 212 (in dotted decimal notation). As may be understood, using the set of hash values each obtained by hashing the overlay multicast address (1.1.1.1, 250.1.1.1) using one of the set of hash functions, viz., Hash1, Hash2, Hash3, and Hash4, the overlay multicast address (1.1.1.1, 250.1.1.1) is mapped to underlay multicast address 227.16.0.64. Similarly, an overlay multicast address (S, G) may be mapped to an underlay multicast address D. The VTEP1 coupled to the source S may store a mapping of overlay multicast address (S, G) 3 underlay multicast address [D]. Although in the above example, an overlay multicast address for a SSM group is mapped, in other examples, an overlay multicast address for an ASM group may also be mapped to an underlay multicast address.

In an example, the set of hash functions is implemented in each virtual endpoint in the overlay network. Thus, in response to receiving the group membership request from the receiver R, VTEP5 may perform the same hash computations to map the overlay multicast address (S, G) to the underlay multicast address D. VTEP5 may send a join request, for joining the multicast group represented by the underlay multicast address D, in the underlay network. In an example, the join request may be a PIM join request. On joining the multicast group in the underlay network, the VTEP5 is configured to receive traffic with destination IP address set as underlay multicast address D. Further, in response to receiving the join request from the VTEP5, the underlay switches 102 may also create a multicast forwarding table for forwarding traffic to the multicast group having underlay multicast address D. The multicast forwarding table may include a route for delivering data packets originating from a source addressed to the underlay multicast address D as the destination.

The source S may forward multicast traffic addressed to the multicast group having overlay multicast address (S, G) to VTEP1. The VTEP1 may receive the multicast traffic for the multicast group from the source S and may encapsulate the multicast traffic with a destination address identical to the underlay multicast address D and a source address identical to its own IP address. In an example, the encapsulation is a VXLAN encapsulation, where a MAC-in-UDP encapsulation scheme is used. In the MAC-in-UDP encapsulation scheme, the original Layer 2 frame has a VXLAN header added to it and is then placed in a UDP-IP packet. In an example, the underlay multicast address D may be used as a destination IP address in the UDP-IP packet and the IP address of VTEP1 may be used as the source address in the UDP-IP packet. The underlay switches may now use the underlay multicast address as the destination IP address while forwarding data packets for the multicast group without being aware of the overlay network topology. Thus, the underlay switches are not required to be configured with overlay network information but can still deliver multicast traffic for the overlay. Consequently, manual configuration of the underlay switches with overlay network information may be avoided.

VTEP1 then forwards the multicast traffic through the underlay network addressed to underlay multicast address D. The underlay network switch 102-2 may receive the multicast traffic from the underlay network, replicate the same and forward it to the underlay multicast address D based on the multicast forwarding table. The VTEP5 which is a member of the multicast group having underlay multicast address D may receive the multicast traffic from the underlay network switch 102-2. VTEP5 may decapsulate the multicast traffic to obtain the overlay multicast address (S, G) as the destination address. Thus, VTEP5 may forward the same to its interface connected to the receiver R which is a member of the multicast group having overlay multicast address (S, G). Thus, multicast traffic may be delivered from the source S to the receiver R via the underlay and overlay networks using an underlay multicast address mapped to an overlay multicast address and without adding protocol extensions or additional headers to the traffic.

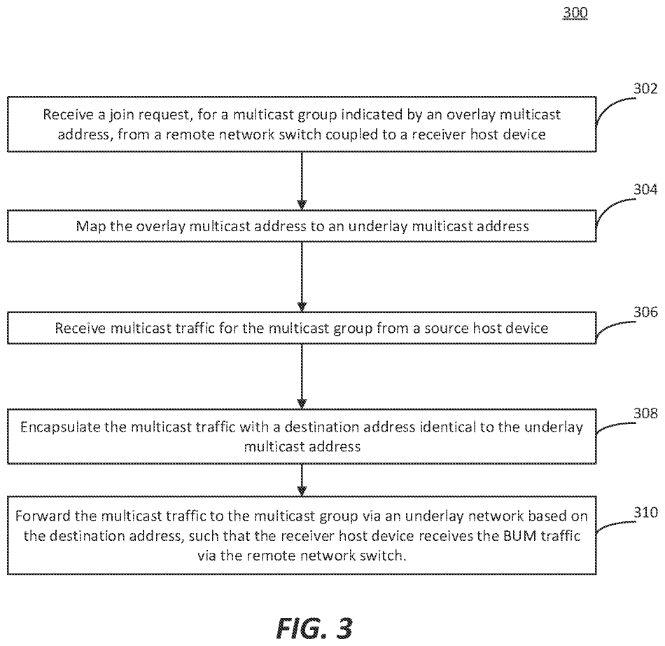

FIG. 3 is a flowchart illustrating a method 300 for multicast traffic handling, according to an example. Method 300 may be executed on a network switch, such as the network switch 108-1 in the network environment 100 of FIG. 1.

At block 302, the network switch may receive a join request, for a multicast group indicated by an overlay multicast address, from a remote network switch. In an example, the network switch is similar to the network switch 108-1 of FIG. 1 and is coupled to a source host device similar to source host device 104-2 of FIG. 1. The remote network switch is similar to the remote network switch 108-5 of FIG. 1 and is coupled to a receiver host device similar to receiver host device 106-1. In an example, the receiver host device belongs to the multicast group. The network switch and the remote network switch may be configured as virtual endpoints in an overlay network deployed over an underlay network. The network switch 108-1 may implement an ingress VTEP and the network switch 108-5 may implement an egress VTEP.

At block 304, the network switch may map the overlay multicast address to an underlay multicast address. In an example, a set of hash functions may be stored in the network switch and the remote network switch. The network switch may determine a set of hash values each obtained by hashing the overlay multicast address using one of the set of hash functions. Each of the set of hash values may correspond to a bit position in an IP address field of the underlay multicast address. The network switch may set the value of a bit corresponding to the bit position as one to obtain the underlay multicast address. Similarly, the remote network switch may also determine the underlay multicast address using the set of hash functions on the overlay multicast address. Further, the remote network switch may join the multicast group represented by the underlay multicast address.

At block 306, the network switch may receive multicast traffic for the multicast group from the source host device. In an example, the multicast traffic may include data packets addressed to the multicast group in which the receiver host device is a member.

At block 308, the network switch may encapsulate the multicast traffic with a destination address identical to the underlay multicast address. In an example, the encapsulation is a VXLAN encapsulation, where a Media Access Control (MAC)-in-User Datagram Protocol (UDP) encapsulation scheme is used. In the MAC-in-UDP encapsulation scheme, the original Layer 2 frame has a VXLAN header added to it and is then placed in a UDP-IP packet. The underlay multicast address is used as a destination IP address in the UDP-IP packet. The underlay switches may now use the underlay multicast address as the destination IP address while forwarding data packets for the multicast group without being aware of the overlay network topology. Thus, the underlay switches are not required to be configured with overlay network information but can still deliver multicast traffic for the overlay. Consequently, manual configuration of the underlay switches with overlay network information may be avoided.

At block 310, the network switch may forward the multicast traffic to the multicast group via the underlay network based on the destination address. In an example, the encapsulated multicast traffic may have the destination address in an outer IP header of UDP-IP packet. Since, the remote network switch is also a member of the multicast group, the multicast traffic forwarded to multicast group may be received by the remote network switch. The receiver host device may receive the multicast traffic via the remote network switch. Thus, multicast traffic may be delivered from the source to the receiver via the underlay and overlay networks using an underlay multicast address mapped to an overlay multicast address and without adding protocol extensions or additional headers to the traffic.

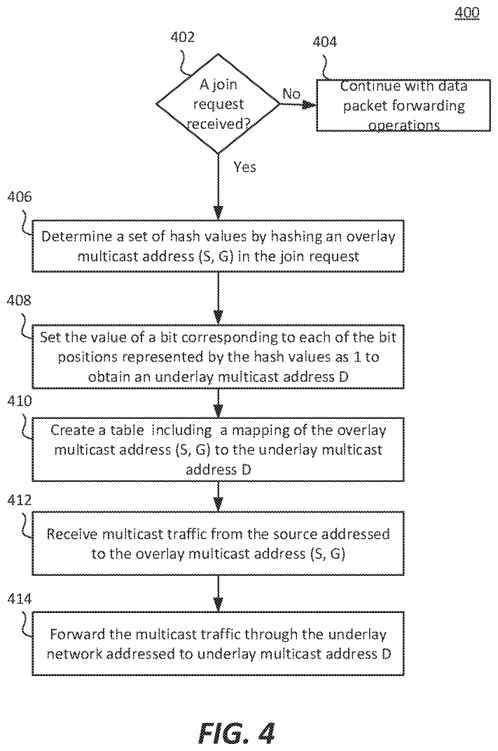

FIG. 4 is a flowchart illustrating a method 400 for multicast traffic handling, according to an example. Method 400 may be executed on a network switch, such as the switch 108-1 in the network environment 100 of FIG. 1.

At block 402, a network switch in a network environment may check for a join request received over its ports/interfaces with other network devices. In an example, the switch may continuously monitor its ports/interfaces to check if the join request is received. The join request may be a network layer protocol communication sent by a remote network switch indicating that it is interested to receive data packets addressed to a multicast group having overlay multicast address (S, G). The multicast group having overlay multicast address (S, G) is also referred to as multicast group (S, G). The multicast group (S, G) may include a set of host devices which are interested to receive data packets originating from source S and addressed to multicast group G. In another example, the overlay multicast address may be denoted as (*, G). In an example, the join request may be a PIM join request. The remote network switch may send the join request in response to receiving a group membership request from a receiver host device.

If no join request is received (“No” branch from block 402), the network switch may continue with its data packet forwarding operations, at block 404. In response to receiving the join request (“Yes” branch from block 402), at block 406, the network switch may determine a set of hash values. Each of the set of hash values may be obtained by applying a hash function, from a set of hash functions, on the overlay multicast address (S, G) and each of the hash values may represent a bit position in an IP address field of an underlay multicast address D corresponding to the overlay multicast address (S, G). The IP address field is a representation of the underlay multicast address D in the binary notation. In an example, the set of hash functions may be stored in a virtual endpoint configured, such as VTEP1 of FIG. 1, in the network switch, such as network switch 108-1. The set of hash functions are configured using a bloom filter technique. In an example bloom filter technique, the hash functions in the set are configured such that the set of hash values range between 1 to M, where M corresponds to a maximum number of variable-value bits in the IP address field. In an example, the value of M may be 28.

Each of the set of hash values correspond to a bit position in the IP address field of the underlay multicast address. At block 408, the network switch may set the value of a bit corresponding to each of the bit positions represented by the hash values as “1”. The bits corresponding to the remaining bit positions may be reset to 0. Thus, we may obtain the underlay multicast address D corresponding to the overlay multicast address (S, G). At block 410, the network switch may create a table including a mapping of the underlay multicast address D to the overlay multicast address (S, G).

In an example, the set of hash functions is implemented in each virtual endpoint in the overlay network. Thus, in response to receiving the group membership request from the receiver host device, an egress VTEP, such as VTEP5, implemented in a remote network switch, such as the network switch 108-5, coupled to the receiver host device, such as receiver 106-1, may also perform the same hash computations to map the overlay multicast address (S, G) to the underlay multicast address D. The egress VTEP may then send a join request, for joining the multicast group represented by the underlay multicast address D, in the underlay network. In an example, the join request may be a PIM join request. On joining the multicast group in the underlay network, the egress VTEP is configured to receive traffic with destination IP address set as underlay multicast address D. Further, in response to receiving the join request from the egress VTEP, the underlay switches, such as switches 102, may also create a multicast forwarding table for forwarding traffic to the multicast group having underlay multicast address D.

During traffic forwarding, the source S may forward multicast traffic addressed to overlay multicast group (S, G) to an ingress VTEP, such as VTEP1, implemented in a network switch, such as network switch 108-1. At block 412, the network switch may receive the multicast traffic for the multicast group from the source S. At block 414, the network switch may encapsulate the multicast traffic with a destination address identical to the underlay multicast address D and a source address identical to its own IP address. In an example, the encapsulation is a VXLAN encapsulation, where a MAC-in-UDP encapsulation scheme is used. In the MAC-in-UDP encapsulation scheme, the original Layer 2 frame has a VXLAN header added to it and is then placed in a UDP-IP packet. In an example, the underlay multicast address D may be used as a destination IP address in the UDP-IP packet and the IP address of VTEP1 may be used as the source address in the UDP-IP packet. The underlay switches may now use the underlay multicast address as the destination IP address while forwarding data packets for the multicast group without being aware of the overlay network topology. Thus, the underlay switches are not required to be configured with overlay network information but can still deliver multicast traffic for the overlay. Consequently, manual configuration of the underlay switches with overlay network information may be avoided.

At block 414, the network switch forwards the multicast traffic through the underlay network addressed to underlay multicast address D. The underlay network switches may receive the multicast traffic from the underlay network, replicate the same and forward it to the underlay multicast address D based on the multicast forwarding table. The egress VTEP which is a member of the multicast group having underlay multicast address D may receive the multicast traffic from the underlay network. The egress VTEP may decapsulate the multicast traffic to obtain the overlay multicast address (S, G) as the destination address. Thus, the egress VTEP may forward the multicast traffic to its interface connected to the receiver which is a member of the multicast group having overlay multicast address (S, G). Thus, multicast traffic may be delivered from the source to the receiver via the underlay and overlay networks using an underlay multicast address mapped to an overlay multicast address and without adding protocol extensions or additional headers to the traffic.

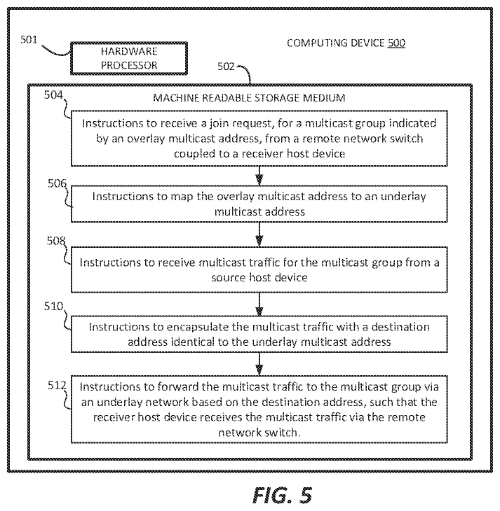

FIG. 5 is an example computing device 500, with a hardware processor 501, and accessible machine-readable instructions stored on a machine-readable medium 502 for implementing one example system, according to one or more disclosed example implementations. In an example, the computing device 500 may be a network switch, such as the switches 106, described above in reference to FIG. 1. FIG. 5 illustrates computing device 500 configured to perform instructions 504-512 described below. However, computing device 500 may also be configured to perform the flow of other methods, techniques, functions, or processes described in this disclosure, such as, for example the method 300 of FIG. 3.

A processing element such as processor 501 may contain one or more hardware processors, where each hardware processor may have a single or multiple processor cores. In one embodiment, the processor 501 may include at least one shared cache that stores data (e.g., computing instructions) that are utilized by one or more other components of processor 501. For example, the shared cache may be a locally cached data stored in a memory for faster access by components of the processing elements that make up processor 501. In one or more embodiments, the shared cache may include one or more mid-level caches, such as level 2 (L2), level 3 (L3), level 4 (L4), or other levels of cache, a last level cache (LLC), or combinations thereof. Examples of processors include but are not limited to a central processing unit (CPU) a microprocessor. Although not illustrated in FIG. 5, the processing elements that make up processor 501 may also include one or more of other types of hardware processing components, such as graphics processing units (GPU), application specific integrated circuits (ASICs), field-programmable gate arrays (FPGAs), and/or digital signal processors (DSPs).

The processor 501 may be operatively and communicatively coupled to a memory. The memory may be a non-transitory computer readable medium, such as the machine readable storage medium 502, configured to store various types of data. For example, the memory may include one or more storage devices that comprise a non-volatile storage device and/or volatile memory. Volatile memory, such as random-access memory (RAM), can be any suitable non-permanent storage device. The non-volatile storage devices can include one or more disk drives, optical drives, solid-state drives (SSDs), tap drives, flash memory, read only memory (ROM), and/or any other type of memory designed to maintain data for a duration of time after a power loss or shut down operation. In certain aspects, the non-volatile storage devices may be used to store overflow data if allocated RAM is not large enough to hold all working data. The non-volatile storage devices may also be used to store programs that are loaded into the RAM when such programs are selected for execution.

The machine-readable storage medium 502 of FIG. 5, may include both volatile and non-volatile, removable and non-removable media, and may be any electronic, magnetic, optical, or other physical storage device that contains or stores executable instructions, data structures, program module, or other data accessible to a processor, for example firmware, erasable programmable read-only memory (EPROM), random access memory (RAM), non-volatile random access memory (NVRAM), optical disk, solid state drive (SSD), flash memory chips, and the like. The machine-readable storage medium may be a non-transitory storage medium, where the term “non-transitory” does not encompass transitory propagating signals.

The machine readable medium 502 includes instructions 504 that, when executed by the processor 501, cause a network switch to receive a join request, for a multicast group indicated by an overlay multicast address, from a remote network switch. In an example, the network switch is similar to the network switch 108-1 of FIG. 1 and is coupled to a source host device similar to source host device 104-2 of FIG. 1. The remote network switch is similar to the remote network switch 108-5 of FIG. 1 and is coupled to a receiver host device similar to receiver host device 106-1. In an example, the receiver host device belongs to the multicast group. The network switch and the remote network switch may be configured as virtual endpoints in an overlay network deployed over an underlay network. The network switch 108-1 may implement an ingress VTEP and the network switch 108-5 may implement an egress VTEP.

The instructions 506, when executed by the processor 501, may cause the network switch to map the overlay multicast address to an underlay multicast address. In an example, a set of hash functions may be stored in the network switch and the remote network switch. The network switch may determine a set of hash values each obtained by hashing the overlay multicast address using one of the set of hash functions. Each of the set of hash values may correspond to a bit position in an IP address field of the underlay multicast address. The network switch may set the value of a bit corresponding to the bit position as one to obtain the underlay multicast address. Similarly, the remote network switch may also determine the underlay multicast address using the set of hash functions on the overlay multicast address. Further, the remote network switch may join the multicast group represented by the underlay multicast address.

The instructions 508, when executed by the processor 501, may cause the network switch to receive multicast traffic for the multicast group from the source host device. In an example, the multicast traffic may include data packets addressed to the multicast group in which the receiver host device is a member.

The instructions 510, when executed by the processor 501, may cause the network switch to encapsulate the multicast traffic with a destination address identical to the underlay multicast address. In an example, the encapsulation is a VXLAN encapsulation, where a Media Access Control (MAC)-in-User Datagram Protocol (UDP) encapsulation scheme is used. In the MAC-in-UDP encapsulation scheme, the original Layer 2 frame has a VXLAN header added to it and is then placed in a UDP-IP packet. The underlay multicast address is used as a destination IP address in the UDP-IP packet.

The instructions 512, when executed by the processor 501, may cause the network switch to forward the multicast traffic to the multicast group via the underlay network based on the destination address. In an example, the encapsulated multicast traffic may have the destination address in an outer IP header of UDP-IP packet. Since, the remote network switch is also a member of the multicast group, the multicast traffic forwarded to multicast group may be received by the remote network switch. The receiver host device may receive the multicast traffic via the remote network switch.

A network switch as used in the examples herein, is a device that receives network traffic and forwards the network traffic to a destination. Some network switches execute packets services, such as application classification and deep packet inspection, on certain network traffic that is received at the network switch. Some network switches monitor load parameters for various physical and logical resources of the network switch, and report load information to a network orchestrator or an orchestrator.

A switch, as used in the examples herein, forwards data (in control packets) between a sender device and a recipient device (or multiple recipient devices) based on forwarding information (or equivalently, “routing information”) accessible by the switch. The forwarding information can include entries that map network addresses (e.g., MAC addresses or IP addresses) and/or ports to respective network paths toward the recipient device(s).

Examples of client devices, as used herein, may include: laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like. Client devices may also be referred to as stations (STA).

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . ”. Also, the term “couple” or “couples” is intended to mean either an indirect or direct wired or wireless connection. Thus, if a first device couples to a second device, that connection may be through a direct connection or through an indirect connection via other devices and connections. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

We claim:

1. A network switch comprising:
a processor;
a non-transitory computer-readable storage medium storing instructions, which when executed by the processor causes the processor to:
receive a join request, for a multicast group indicated by an overlay multicast address, from a remote network switch, wherein the network switch is coupled to a source host device and the remote network switch is coupled to a receiver host device of the multicast group, and wherein the network switch and the remote network switch are configured as virtual endpoints in an overlay network deployed over an underlay network;
map the overlay multicast address to an underlay multicast address, wherein the remote network switch joins the multicast group represented by the underlay multicast address, wherein to map the overlay multicast address, the processor is to:
determine a set of hash values each obtained by hashing the overlay multicast address using one of a set of hash functions, wherein each of the set of hash values corresponds to a bit position in an IP address field of the underlay multicast address; and
set the value of a bit corresponding to the bit position as one;
receive multicast traffic for the multicast group from the source host device;
encapsulate the multicast traffic with a destination address identical to the underlay multicast address; and
forward the multicast traffic to the multicast group via the underlay network based on the destination address, such that the receiver host device receives the multicast traffic via the remote network switch.

2. The network switch of claim 1, wherein the overlay multicast address includes at least one of an Internet Protocol (IP) address of the source host device and an IP address of the multicast group in an overlay address space.

3. The network switch of claim 1, wherein the underlay multicast address includes an IP address of the multicast group in an underlay address space.

4. The network switch of claim 1, wherein the set of hash functions is implemented in each virtual endpoint in the overlay network.

5. The network switch of claim 1, wherein the join request is a Protocol Independent Multicast (PIM) join request.

6. The network switch of claim 1, wherein the underlay network comprises switches storing a multicast forwarding table comprising the map of the overlay multicast address to the underlay multicast address.

7. The network switch of claim 1, wherein the join request originates from the remote network switch in response to the remote network switch receiving a group membership request for the multicast group from the receiver host device.

8. The network switch of claim 1, wherein the multicast group is one of a source specific multicast (SSM) group or an any-source multicast (ASM) group.

9. A method comprising:
receiving a join request, for a multicast group indicated by an overlay multicast address, from a remote network switch, wherein the network switch is coupled to a source host device and the remote network switch is coupled to a receiver host device of the multicast group, and wherein the network switch and the remote network switch are configured as virtual endpoints in an overlay network deployed over an underlay network;
mapping the overlay multicast address to an underlay multicast address, wherein the remote network switch joins the multicast group represented by the underlay multicast address, wherein the mapping comprises:
determining a set of hash values, each obtained by hashing the overlay multicast address using one of a set of hash functions, wherein each of the set of hash values corresponds to a bit position in an IP address field of the underlay multicast address; and
setting the value of a bit corresponding to the bit position as one;
receiving multicast traffic for the multicast group from the source host device;
encapsulating the multicast traffic with a destination address identical to the underlay multicast address; and
forwarding the multicast traffic to the multicast group via the underlay network based on the destination address, such that the receiver host device receives the multicast traffic via the remote network switch.

10. The method of claim 9, wherein the overlay multicast address includes at least one of an Internet Protocol (IP) address of the source host device and an IP address of the multicast group in an overlay address space.

11. The method of claim 9, wherein the underlay multicast address includes an IP address of the multicast group in an underlay address space.

12. The method of claim 9, wherein the set of hash functions is implemented in each virtual endpoint in the overlay network.

13. The method of claim 9, wherein the join request is a Protocol Independent Multicast (PIM) join request.

14. The method of claim 9, wherein the underlay network comprises switches storing a multicast forwarding table comprising the map of the overlay multicast address to the underlay multicast address.

15. The method of claim 9, wherein the join request originates from the remote network switch in response to the remote network switch receiving a group membership request for the multicast group from the receiver host device.

16. The method of claim 9, wherein the multicast group is one of a source specific multicast (SSM) group or an any-source multicast (ASM) group.

17. A non-transitory, computer readable medium including instructions that, when executed by a processor, cause a network switch to:
receive a join request, for a multicast group indicated by an overlay multicast address, from a remote network switch, wherein the network switch is coupled to a source host device and the remote network switch is coupled to a receiver host device of the multicast group, and wherein the network switch and the remote network switch are configured as virtual endpoints in an overlay network deployed over an underlay network;
map the overlay multicast address to an underlay multicast address, wherein the remote network switch joins the multicast group represented by the underlay multicast address, wherein to map the overlay multicast address, the processor is to:
determine a set of hash values each obtained by hashing the overlay multicast address using one of a set of hash functions, wherein each of the set of hash values corresponds to a bit position in an IP address field of the underlay multicast address; and
set the value of a bit corresponding to the bit position as one;
receive multicast traffic for the multicast group from the source host device;
encapsulate the multicast traffic with a destination address identical to the underlay multicast address; and
forward the multicast traffic to the multicast group via the underlay network based on the destination address, such that the receiver host device receives the multicast traffic via the remote network switch.

18. The non-transitory computer-readable medium of claim 17, wherein the overlay multicast address includes at least one of an Internet Protocol (IP) address of the source host device and an IP address of the multicast group in an overlay address space.

19. The non-transitory computer-readable medium of claim 17, wherein the underlay multicast address includes an IP address of the multicast group in an underlay address space.

20. The non-transitory computer-readable medium of claim 17, wherein the set of hash functions is implemented in each virtual endpoint in the overlay network.
